(19) United States
(12) Patent Application Publication
(10) Pub. No.: US 2026/0062301 A1
(43) Pub. Date: Mar. 5, 2026

(54) PROCESSING SYSTEM AND METHOD WITH A SINGLE VARIABLE RPM MILL FOR MANUFACTURING SPHEROIDIZED GRAPHITE POWDER

(71) Applicant: EPSILON ADVANCED MATERIALS PRIVATE LIMITED, Maharashtra (IN)

(72) Inventor: Natarajan CHINNASAMY, Tamil Nadu (IN)

(21) Appl. No.: 19/108,247

(22) PCT Filed: Jan. 9, 2023
(86) PCT No.: PCT/IB2023/058660

§ 371 Date: Mar. 3, 2025

(30) Foreign Application Priority Data
Sep. 2, 2022 (IN) 202221050308

(51) Int. Cl. C01B 32/205

(52) U.S. Cl. CPC C01B 32/205; C01P 2004/32; C01P 2004/61; C01P 2004/84; C01P 2006/11; C01P 2006/12; C01P 2006/20

(57) ABSTRACT

The present disclosure relates to a system (100) for manufacturing spheroidized graphite powder, the system includes a feeder (104) adapted to convey primarily crushed particles to a grinding section (106). A first classifier (108) is located at the top portion of the chamber and is configured to receive the milled particles and adapted to separate the milled particles into a first particle and a second particle. A controller (112) operatively coupled to the one or more motors (110), the controller configured to operate the one or more motors at progressively varying RPM, at higher RPM it cuts the rough edges of the particle to form the first fine graphite particle and second shaped graphite particle and when the it RPM decreased to lower level, the surface smoothening of shaped particle process occurs, which results smooth surfaced spherical graphite.

### TECHNICAL FIELD

The present disclosure relates, in general, to graphite spheroidizing, and more specifically, relates to a processing system and method with a single, variable RPM mill for manufacturing spheroidized graphite powder.

### BACKGROUND

Graphite particles have found wide applications as an anode material for lithium-ion secondary batteries and in fuel cells bipolar plates and the like. The natural graphite flake materials are typically flat in shape with sharp edges with low tap density, which makes the anode for Li-ion battery preparation difficult. Moreover, it leads to lower electrode density resulting in lower energy density of the battery and a poor life cycle.

Further, the natural graphite flakes tend to orient themselves in parallel to the current collector during electrode preparation. This orientation slows down the Lithium-ion batteries intercalation and de-intercalation process, as the lithium ions cannot enter the graphite crystal through its “basal plane surface”, which is oriented towards the electrolyte, but have to migrate around the flakes to the “prismatic surface planes”.

Therefore, the processes of manufacturing spherical graphite from the graphite flak and coke materials are highly needed. The process should yield spherical graphite particles with high tap density, smooth surface, and higher compactness resulting in high electrode density, low cost, and high lithium insertion capacity.

In the conventional processes, as per the patent CN101391105A, CN110872118A, manufacturing of the spherical graphite requires multi-steps, which makes the processes very expensive and time-consuming. This system is configured to feed the flake graphite that has been ground in primary crushers to the required size of D50=10-30 micron and then feed to secondary crushers 2 to 5 numbers in sequence, then feed to shaping crushers 10 to 12 numbers in series and at the end of the shaping crushers the spherical graphite product is collected.

So, the conventional processes require multiple systems, around 20 systems for manufacturing graphite with a spherical shape. Each system consists of one feeder, mill, primary classifier, secondary classifier, bag filler, blower, and control system. This multi-system makes these processes very difficult to control and operate.

Another example is recited in a patent U.S. Pat. No. 6,939,526 B2 that relates to the soft flaky particle that is folded, like a spherical onion layer and made into spherical graphite. However, due it its soft nature, while calendaring the electrode to higher electrode density, the particle tends to break and flatten resulting in the closing of surface porosity, which would result in a low rate of charging and discharging performance.

Yet another example is recited in a patent CN112110444A. The system includes three griding sections in a single chamber with three drives. The grinded/shaped particle with fines comes out of the grinding chamber and is classified and then large particles are directed to the grinding chamber and fines are collected at the bottom of the cyclone. The drives/motors have the option to vary the revolutions per minute (RPM) of the motor. However, the process is performed at the required-fixed RPM. This system also required multiple drives in the grinding chamber.

Yet another method disclosed in US2013/0130117A1 describes making spherical graphite in one machine and then again feeding the intermediate particle to another mechanical grinding machine for particle surface smoothing. Though it reduces the number of steps, still it needs multi-step and multiple machinery.

Therefore, it is desired to overcome the drawbacks, shortcomings, and limitations associated with existing solutions, and develop a process for manufacturing spherical graphite that may eliminate the multiple steps used in the conventional processes for spheroidization and smoothing of the graphite materials.

### OBJECTS OF THE PRESENT DISCLOSURE

An object of the present disclosure relates, in general, to graphite spheroidizing. and more specifically, relates to a processing system and method with a single grinding chamber with a single griding drive with continuously/progressively changing the RPM of mill for manufacturing spheroidized graphite powder.

Another object of the present disclosure is to provide a system that enables the shaping process and surface smoothening of the particles done in the same grinding chamber by continuously/progressively changing the RPM of the mill drive.

Another object of the present disclosure is to provide a system that yields spherical graphite particle, which does not break and flatten during the electrode manufacturing process to have the high-rate performance of the electrode.

Another object of the present disclosure is to provide a system that is easy to operate and control.

Yet another object of the present disclosure is to provide a few motors, mills and classifiers resulting in a cost-effective system.

### SUMMARY

The present disclosure relates in general, to graphite spheroidizing, and more specifically, relates to a processing system and method with a single grinding chamber, with continuously/progressively changing the RPM of the mill for manufacturing spheroidized graphite powder. The main objective of the present disclosure is to overcome the drawbacks, limitations, and shortcomings of the existing systems and solutions, by providing a system and method with a single, continuously/progressively variable RPM of the mill for manufacturing spheroidized graphite powder.

The present disclosure relates to a feeder adapted to convey primarily crushed particles to a grinding/shaping section enclosed in a chamber. The particles are selected from natural graphite, petroleum and coal tar-based coke powder and any combination thereof. These modified natural graphite/coke particles are obtained by a manufacturing method including a step of applying an impact force to natural graphite/coke particles for cutting of random edges and spheroidization at high RPM and when the RPM continuously/progressively reduced to enable the smoothing of the surface of the particle.

A first classifier is located at the top portion of the chamber. The first classifier is configured to receive the milled/shaped particles and adapted to separate the powders into a first particle and a second particle. The first particle is a fine graphite particle and the second particle is a spherical graphite particle. One motor is coupled to the grinding section and another motor is coupled with the first classifier. The grinding and classifier motors can be operated independently to be rotated at a variable RPM from high to low or low to high, either progressively/continuously. The variation of RPM of the grinding motors is described, where x=RPM of milling-y and y is between 0 to 200 RPM. The variation of RPM of the classifiers-1 is shown, where m=RPM of 70% of the maximum RPM of the classifier-n, where n is between 0 to 50 RPM.

A controller operatively coupled to one or more motors, the controller configured to operate one or more motors at a high RPM to cut the rough edges of the particle at higher RPM to form the first and second particle. The controller is configured to operate the classifier at lower RPM to facilitate the first fine graphite particle that is removed through the first classifier and the second particle further directed to the grinding chamber, where the shaped particle's surface is smoothened at the low RPM of the grinding mill to form the spherical graphite thereby facilitating the smoothening and shaping process in single grinding system.

Further, the spherical shaping process is performed in a single mill by applying impact force and shear forces, where the forces are generated by a rotating hammer and fixed liner in the mill with a variable RPM of the rotor, thereby grinding graphite in a short time. The smooth spherical graphite with low surface area is obtained by rotating the rotor of one or more motors with variable RPM from high to low RPM.

In addition, the spherical graphite is coated with a carbon source such as pitch followed by carbonization/graphitization resulting in spherical graphite anode powder, where the purified spherical graphite has a surface area of less than 2 m²/g with a high tap density of 1.2 g/cc, which provides 368 mAh/g and first cycle columbic higher efficiency of 94%. The spherical graphite made by the declared process shows an orientation index of less than 50. The orientation index is measured by the ratio of I₀₀₂/I₁₁₀ peak by powder x-ray diffraction analysis. The lower the index would be better for the high rate and long cycle life cells.

The surface area of the as-made spherical graphite particle at a diameter of D50 of the size of 10 μm is less than 8 m2/g and the diameter of D50 of size 15 μm is less than 6 m2/g with a smooth surface. The spherical graphite particle obtained having a length-to-diameter (L/D) ratio in the optimal range of 1.2 having a shaping yield of more than 65% and a tap density of 0.99 for the diameter D50 of 10 μm.

Those skilled in the art would appreciate that a large number of motors, mills and classifiers are avoided in the present invention, the additional particle usage and additional assembly operation may not be required, thereby reducing the cost of the system. Besides, the system can use only around ten motors for the milling and spheroidization, which would be easy to operate and control.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1A illustrates an exemplary single mill grinding and first classifier in accordance with an embodiment of the present disclosure.

FIG. 1B illustrates an exemplary spherical shaping process system in accordance with an embodiment of the present disclosure.

FIG. 1C illustrates an exemplary block diagram of the single processing system, in accordance with an embodiment of the present disclosure.

FIG. 2A illustrates an exemplary block diagram of the RPM variation for the grinding motors, in accordance with an embodiment of the present disclosure.

FIG. 2B illustrates an exemplary block diagram of the RPM variation for the first classifier motors, in accordance with an embodiment of the present disclosure.

FIGS. 3A to 3D illustrate exemplary view of the scanning electron microscope (SEM) of the spheroidized graphite, in accordance with an embodiment of the present disclosure.

FIG. 4 illustrates an exemplary method for manufacturing spheroidized graphite powder, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure relates, in general, to graphite spheroidizing, and more specifically, relates to a processing system and method with a single system with continuously/progressively changes the RPM of the mill for manufacturing spheroidized graphite powder.

The term “spheroidization” herein refers to the shaping of the graphite flakes particles into spherical or nearly spherical shape graphite particles.

The proposed system disclosed in the present disclosure overcomes the drawbacks, shortcomings, and limitations associated with the conventional systems by providing a system that includes a feeder adapted to convey primarily crushed particles to the grinding section enclosed in the chamber. The particles are selected from natural graphite flake, petroleum and coal tar-based coke powder and any combination thereof. The term “flake” describes crystalline graphite comprised of highly ordered layers, which ultimately defined the size ratio of the particle.

Further, the first classifier is located at the top portion of the grinding chamber, the first classifier is configured to receive the milled particles and adapted to separate the milled particles into a first particle and a second particle. The controller is configured to operate one or more motors to change the RPM continuously/progressively, to cut the rough edges of the particle to form the fine graphite particle and gradually decrease at the low RPM, to smoothen the surface of the particle to form the spherical graphite that is created towards the end of the process. The fine graphite particles are passed from a top outlet of the chamber to a first enclosure and the spherical graphite is passed from a middle outlet of the chamber after shaping is performed for a pre-set time to a second classifier.

The controller is configured to perform the spherical shaping process by applying impact force and shear forces, the forces are generated by a rotating hammer and fixed liner of the grinding section with the variable frequency of the rotor. The spherical graphite particle obtained having a length-to-diameter (L/D) ratio in the optimal range of less than 1.2 with a shaping yield of more than 65%.

In addition, the spherical graphite is coated with a carbon source, such as pitch, and followed by carbonization/graphitization at a temperature in a range of 2600° C. to 2900° C., resulting in graphite anode powder, where the purified spherical graphite is having a surface area of less than 2 m²/g and 1.2 g/cc tap density material for 10 micron powder.

The processed graphite anode powder provides more than 365 mAh/g as discharge capacity and more than 93% first cycle efficiency. The present disclosure can be described in enabling detail in the following examples, which may represent more than one embodiment of the present disclosure.

The advantages achieved by the system of the present disclosure can be clear from the embodiments provided herein. The system enables the surface area shaping and smoothening process of the particles. The system avoids breaking and flattening the particles during electrode calendaring, which results in high-rate performance. The present disclosure provides a few motors, mills and classifiers resulting in a cost-effective system and easy to operate and control. The description of terms and features related to the present disclosure shall be clear from the embodiments that are illustrated and described; however, the invention is not limited to these embodiments only. Numerous modifications, changes, variations, substitutions, and equivalents of the embodiments are possible within the scope of the present disclosure. Additionally, the invention can include other embodiments that are within the scope of the claims but are not described in detail with respect to the following description.

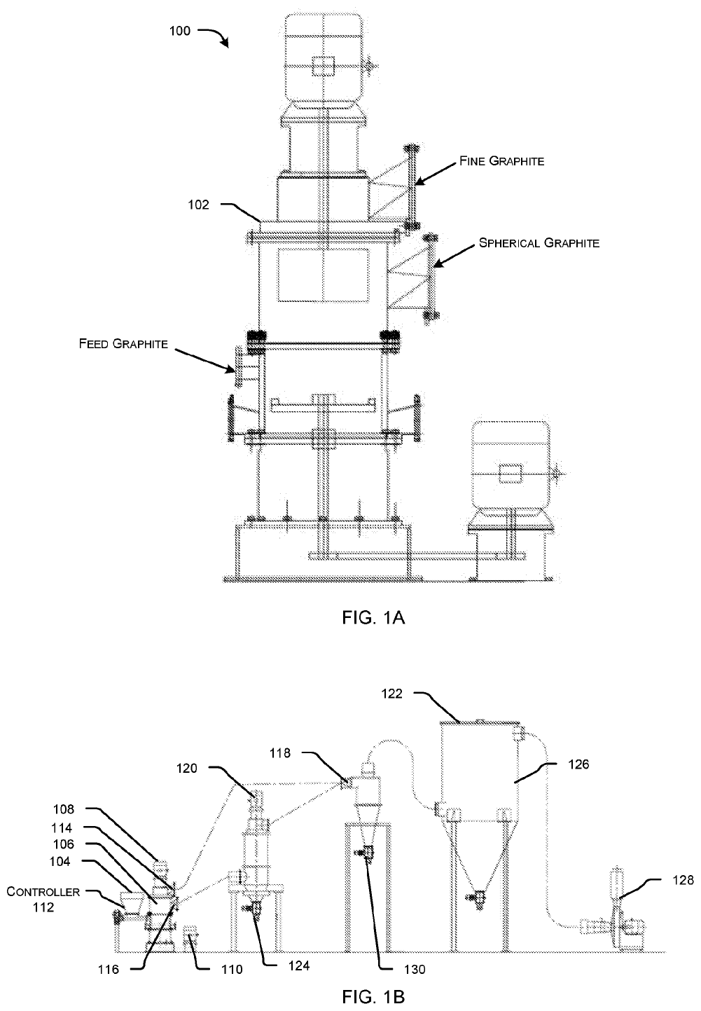

FIG. 1A illustrates an exemplary single mill grinding and first classifier in accordance with an embodiment of the present disclosure.

Referring to FIG. 1A, a single mill processing system 100 (also referred to as system 100, herein) is configured to perform spheroidization of graphite. System 100 can include a feeder 104, a grinding section 106, a first classifier 108, programmable logic controller (PLC) 112 and motors 110 enclosed in chamber 102. The particle as presented in the example can be natural flake graphite or coke particle.

In an embodiment, the particle is conveyed to the grinding section 106 through feeder 104, where the deformation of the particle is obtained. The particle is primarily crushed around 20 micrometres in a primary crusher and fed to the grinding section 106 in chamber 102. The grinding section 106 is coupled to the first classifier 108 which is located at the top portion of chamber 102. Chamber 102 can include a top outlet 114 and a middle outlet 116. The top outlet 114 of chamber 102 is coupled to a first enclosure 118 and the middle outlet 116 is coupled to a second classifier 120. The first enclosure 118 is coupled to a second enclosure 122, where the second enclosure 122 can include a bag filter 126 and finally, the second enclosure 122 is coupled to a blower 128.

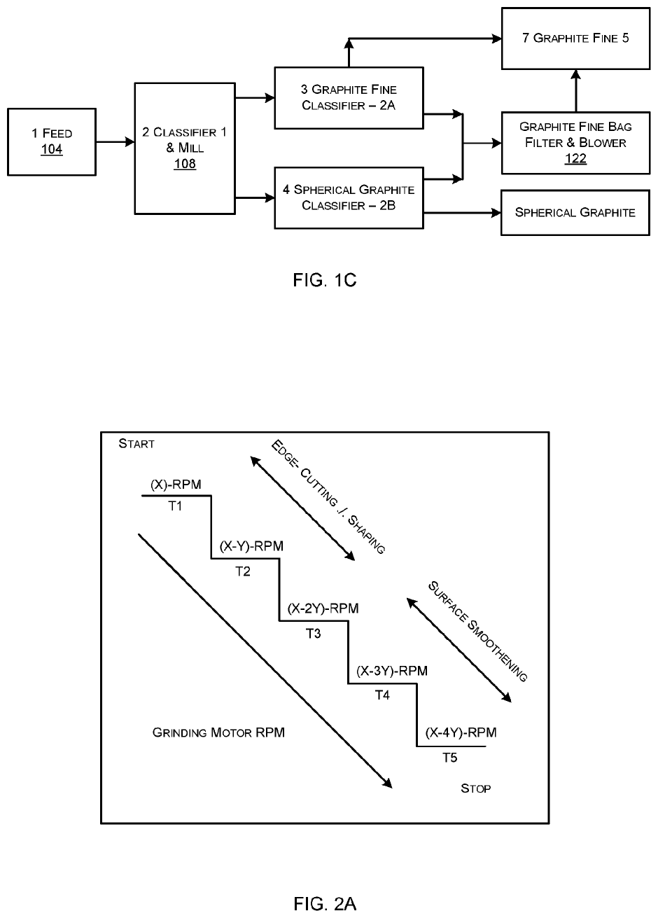

In an embodiment, one or more motors 110 are coupled to the grinding section 106 and the first classifier 108. The one or more motors 110 operated to be rotated at a progressively variable frequency from high to low or low to high RPM. The programmable logic controller (PLC) (also referred to as controller 112, herein) is operatively coupled to one or more motors 110 and valves (124, 130). The PLC 112 is configured to operate one or more motors 110 at a variable RPM. The controller 112 is configured to operate one or more motors 110 with progressively varying RPM at high RPM to cut off the rough edges of the particle and then gradually decrease to low RPM to enable a smooth surface of graphite. The controller 112 is configured as shown FIG. 2A and FIG. 2B respectively to perform a spherical shaping process in the single mill shown in FIG. 1A and 1B respectively, by applying impact and shear forces created by rotating hammer and fixed liner in the system 100 with the variable frequency of the rotor, therefore facilitating grinding of the particles in a short time. The hammer is made of hardened steel and carbide tip hammers. The liner is made of hardened steel material with 4 times the height of the hammer height.

The first classifier 108 is configured to receive the milled particles and adapted to separate the milled particles e.g., graphite into a first particle and a second particle. The first particle can be fine graphite particles and the second particle can be spherical graphite. Further, the first classifier 108 can allow only fine graphite particles to be dispensed from the top outlet 114 of chamber 102 and the shaped particle i.e., spherical graphite is collected at the middle outlet 116 of chamber 102 after shaping is performed for a pre-set time.

For example, the particles are fed inside the chamber for 15 minutes. Initially, when the motor 110 is kept at high RPM, the edges of the flake are cut and start to bend. The irregular edges of the particle are cut to form a fine graphite particle and the motor 110 gradually decreased to a low RPM of the frequency, the edges are folded to smoothen the surface to form a spherical graphite particle. The fine particle is allowed to pass through the top outlet 114 of chamber 102. After the pre-set time, valve is opened and the shaped particle e.g., spherical graphite is passed through the middle outlet 116 and collected at the bottom section of the second classifier 120.

The fine particles are passed to valve 130 located in first enclosure 118 and further processed with bag filter 126 provided in the second enclosure 122 and conveyed to the blower 128 to obtain the fine graphite particles. The spherical graphite is passed to the second classifier 120 and collected at the bottom section of the second classifier 120 through a discharge valve 124.

FIG. 1C illustrates an exemplary block diagram of the single processing system, in accordance with an embodiment of the present disclosure. The particle is conveyed to the grinding section 106 through feeder 104. The grinding section 106 is coupled to the first classifier 108, the first classifier 108 is configured to receive the milled particles and adapted to separate the milled particles into the first particle and the second particle. The controller 112 operatively coupled to the one or more motors 110 at the high RPM, to cut the rough edges of the particle to form the first particle pertaining to fine graphite particle and operate at the low RPM, to smoothen the surface of the particle to form the second particle pertaining to spherical graphite. The spherical natural graphite obtained by this process can be coated with a

carbon source, such as pitch and processed at a temperature of about 2600 C-2900 C for carbon coating and purification process together. The spherical graphite is coated with pitch followed by carbonization/graphitization resulting in the spherical graphite powder with less than 2 m²/g surface area and 1.15 g/cc tap density material. Firstly, the pitch-coated graphite is heat-treated at 500° C. for about 30 min and then carbonized at 1,000° C. for about an hour. Thereafter, the graphitization is done at a temperature of about 2900° C.

In the embodiment, the coating is essentially a partially graphitized carbon shell which protects the spherical graphite particles from exfoliation and improves cycle stability by suppressing the reaction between the electrolyte and the graphite particles, which as a result increases the battery capacity and life. Further, carbon coating such as pitch-derived amorphous carbon coating effectively decreases irreversible capacity. The coating of the carbon pitch may also be done by solvent or other coating techniques.

The purification of the spherical graphite particles is carried out to remove deleterious elements including silicon dioxide (SiO2), Iron (Fe), and other metal elements. The purification is carried out by some purification techniques such as aggressive acid purification with hydrofluoric acid and thermal purification, or other similar techniques. The spherical graphite particles obtained after the thermal purification are having a surface area of less than 2 m²/g and a tap density of 1.2 g/cc, which shows the very high spherical nature of the particles.

The purified natural graphite had a surface area of less than 2 m²/g with a high tap density of 1.2 g/cc, which gave 368 mAh/g and first cycle columbic efficiency of 94%. The powder orientation index of spherical graphite is less than 70, as analyzed by the powder X-ray diffraction method.

The surface area of the uncoated spherical graphite particle at a diameter of D50 of the size of 10 μm is less than 8 m2/g and at the diameter of D50 of size 15 μm is less than 6 m2/g with a smooth surface. The spherical graphite particle obtained having a length-to-diameter (L/D) ratio in the optimal range of 1.2 having a shaping yield of more than 65% and a tap density of 0.99 for the diameter D50 of 10 μm. The lower L/D ratio, higher tap density and lower surface area indicate good spherical nature with a smooth surface.

Referring to FIG. 2A and FIG. 2B, the variation of RPM of the grinding motors is shown in FIG. 2A, where x=RPM of milling and y is between 0 to 200 RPM. The variation of RPM of the first classifiers is shown in FIG. 2B, where m=RPM of 70% of the maximum RPM of the classifier-n and n is between 0 to 50 RPM.

Thus, the present invention overcomes the drawbacks, shortcomings, and limitations associated with existing solutions, and provides a cost-effective system that reduces the defects to have shaped graphite with less surface area. The generation of fine powder is also reduced to improve the yield. This is achieved by continuously changing the RPM from high to low at a pre-determined rate of decrease. At the higher end of the frequency, the irregular edges of the particles are cut and at the lower end of the frequency, the edges are folded and smoothened on the surface. Further, the system can use only around ten motors for the milling and spheroidization, which would be easy to operate and control, thereby reducing capital costs.

### Experimental Results

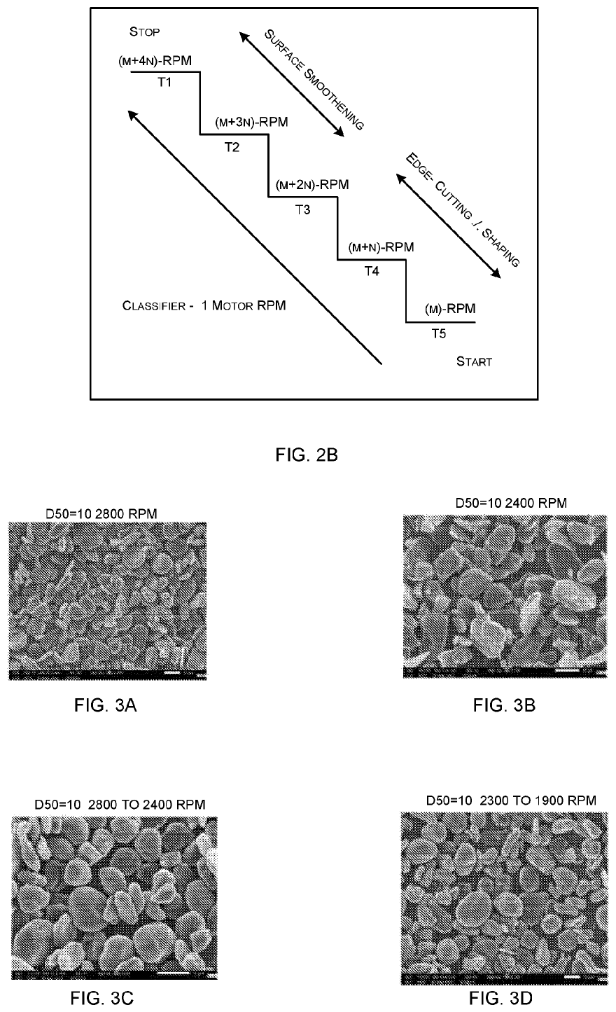

FIGS. 3A to 3D illustrate the exemplary view of the scanning electron microscope (SEM) of the spheroidized graphite, in accordance with an embodiment of the present disclosure. As depicted in FIG. 3A and FIG. 3B, the diameter size D50 of the graphite particle is considered and when the controller operates the motor at 2800 RPM (Com.Ex-1) or 2400 RPM (Com.Ex-2), the proper shape of the particle is not obtained. Therefore, to obtain D50 of 10 micnron graphite particle (Ex-1) and the controller operating the grinding motor from 2800 RPM to 2400 RPM progressively reduced as indicated in FIG. 2A. Where x=2800 RPM, y=100 RPM & T1 to T5=3 min. The classifier motor is controlled as per FIG. 2B, where m=2600 RPM, n=50 RPM and T1 to T5=3 min. The progressive control of the RPM yields good spherical particles with smooth surfaces as indicated in FIG. 3C.

Similarly, to obtain a D50 of 15-micron graphite spherical particle, the RPM is adjusted as below; the grinding motor from 1300 RPM to 1900 RPM progressively reduced as indicated in FIG. 2A. Where x=1300 RPM, y=100 RPM & T1 to T5=3 min. The classifier motor is controlled as per FIG. 2B, where m=2600 RPM, n=50 RPM and T1 to T5=3 min. This process, Example-2, gives 15 micorn spherical graphite powder with a Tap density of more 1.02 g/cc and surface area less than 6 m2/g.

The proposed system 100 can operate to make different particle sizes by optimizing the process parameter. It can give 10-micron particles and 15-micron particles by the same process with different parameters as shown in Ex-1 and Ex-2. The experimental data for manufacturing spheroidized graphite from a single processing system is described in table 1 below.

TABLE 1
Experimental data for manufacturing of spheroidized
graphite from a single processing system.

| | Unit | Com-Ex 1 | Com-Ex 2 | Ex-1 | Ex-2 |
|---|---|---|---|---|---|
| Grade | | 10-1 | 10-2 | 10-3 | 15 |
| Feed | Kg | 5 | 5 | 5 | 5 |
| Mill | RPM | 2800 | 2400 | 2800 to 2400 | 1300 to 1900 |
| Mill-Time | min | 15 | 15 | 15 | 15 |
| Classifier-1 | Hz | 2800 | 2800 | 2600 to 2800 | 2600 to 2800 |
| D10 | mm | 6.4 | 6..7 | 7.3 | 9.4 |
| D50 | mm | 9.7 | 10.7 | 10.5 | 14.6 |
| D90 | mm | 17.2 | 15.6 | 16.8 | 22.5 |
| Tap | g/cc | 0.88 | 0.72 | 0.99 | 1.02 |
| OI XRD | Ratio | 63 | 169 | 40 | 62 |
| I002/I110 | | | | | |
| SSA | m²/g | 10.9 | 13.7 | 7.9 | 5.8 |

However, these are just exemplary values, and the actual values can be a wide range, and the values included here are just for illustrative purposes other values and integer multiples are possible as well.

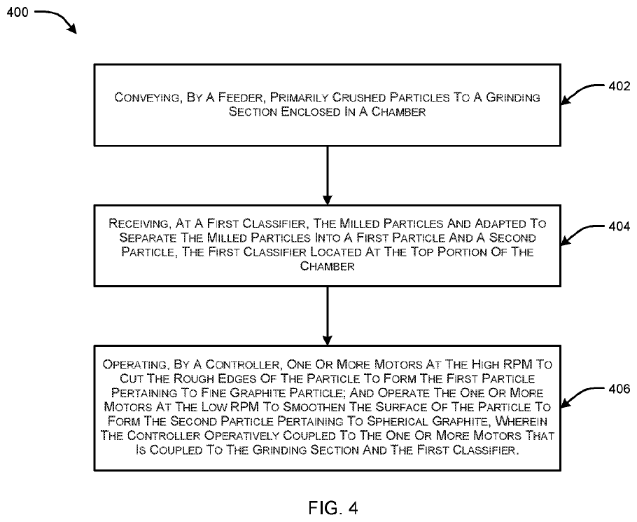

FIG. 4 illustrates an exemplary method for manufacturing spheroidized graphite powder, in accordance with an embodiment of the present disclosure.

Referring to FIG. 4, method 400 for manufacturing spheroidized graphite powder. At block 402, the feeder can convey primarily crushed particles to the grinding section enclosed in a chamber. At block 404, the first classifier can receive the milled particles and adapt to separate the milled particles into the first particle and the second particle, the first classifier is located at the top portion of the chamber.

At block 406, the controller can operatively be coupled to the first classifier and can operate one or more motors at the progressively varying RPM, at the high RPM to cut the rough edges of the particle to form the first particle and operate at the low RPM, to smoothen the surface of the particle to form the second particle. The one or more motors coupled to the grinding section and the first classifier, the one or more motors adapted to be rotated at a variable frequency from high to low or low to high RPM.

It will be apparent to those skilled in the art that the system 100 of the disclosure may be provided using some or all of the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

Advantages of the Present Invention

The present invention provides a system that enables the shaping and surface smoothening process of the particles.

The present invention provides a system that avoids breaking and flattening the particles during calendaring, which results maintain uniform porosity in the electrode which would help high-rate performance and long cycle.

The present invention provides a system that is easy to operate and control.

The present invention provides a few motors, mills and classifiers resulting in a cost-effective system.

1. A system for manufacturing spheroidized graphite powder, the system comprising:
a feeder adapted to convey primarily crushed particles to a grinding section enclosed in a chamber;
a first classifier located at the top portion of the chamber, the first classifier is configured to receive the milled particles and adapted to separate the milled particles into a first particle and a second particle;
one or more motors coupled to the grinding section and the first classifier, the one or more motors operated to be rotated at a progressively variable frequency from high to low or low to high revolution per minute; and
a controller operatively coupled to the one or more motors, the controller configured to:
operate, the one or more motors, with progressively varying RPM, at high RPM to cut the rough edges of the particle to form the first particle pertaining to a fine graphite particle; and
operate, the one or more motors, with progressively varying RPM, at low RPM, to smoothen the surface of the particle to form the second particle pertaining to spherical graphite particle.

2. The system as claimed in claim 1, wherein the particles are selected from natural graphite, artificial graphite, petroleum coke powder and any combination thereof.

3. The system as claimed in claim 1, wherein the fine graphite particles are passed from a top outlet of the chamber to a first enclosure and the spherical graphite particle is passed from a middle outlet of the chamber after shaping for a pre-set time to a second classifier.

4. The system as claimed in claim 1, wherein the spherical graphite particle is coated with carbon pitch followed by carbonization resulting in the spherical graphite powder, wherein the purified spherical graphite particle is having a surface area less than 2 m²/g and 1.2 g/cc tap density material.

5. The system as claimed in claim 1, wherein the powder orientation index of spherical graphite particle is less than 40.

6. The system as claimed in claim 1, wherein the smooth spherical graphite particle with low surface area is obtained by rotating the rotor of one or more motors with progressively varying RPM.

7. The system as claimed in claim 1, wherein the spherical graphite particle obtained having length-to-diameter (L/D) ratio in the optimal range of 1.2 having shaping yield of more than 65% and tap density of 0.99 g/cc for the diameter D50 of 10 microns(μm).

8. The system as claimed in claim 1, wherein the surface area of the spherical graphite particle at a diameter D50 of size 10 μm is less than 8 m2/g and at the diameter D50 of size 15 μm is less than 6 m2/g with the smooth surface.

9. The system as claimed in claim 1, wherein the controller is configured to perform a spherical shaping process by applying impact force and shear forces, the forces are being generated by a rotating hammer and fixed liner of the grinding section with the variable frequency of the rotor, wherein the spherical graphite particle formed.

10. A method for manufacturing spheroidized graphite powder, the method comprising:
conveying, by a feeder, primarily crushed particles to a grinding section enclosed in a chamber;
receiving, at a first classifier, the milled particles and adapted to separate the milled particles into a first particle and a second particle, the first classifier located at the top portion of the chamber; and
operating, by a controller, one or more motors, with progressively varying RPM, at the high RPM to cut the rough edges of the particle to form the first particle pertaining to fine graphite particle, and operate the one or more motors with progressively varying RPM at the low RPM to smoothen the surface of the particle to form the second particle pertaining to spherical graphite, wherein the controller operatively coupled to the one or more motors that are coupled to the grinding section and the first classifier.
